(19) United States
(12) Patent Application Publication
(10) Pub. No.: US 2002/0048986 A1
(43) Pub. Date: Apr. 25, 2002

(54) Electrical connector with discrete sections

(76) Inventors: Richard Lee Lewis, Manchester, MD (US); Paul G. Rutledge, Lancaster, PA (US)

Correspondence Address: Woodcock Washburn Kurtz, Mackiewicz & Norris LLP, 46th Floor, One Liberty Place, Philadelphia, PA, 19103, US

(21) Appl. No.: 09/879,409

(22) Filed: Jun. 12, 2001

Related U.S. Application Data
(60) Provisional application No. 60/218,982, filed on Jul. 17, 2000.

(51) Int. Cl. H01R 13/625; H01R 4/50

(52) U.S. Cl. 439/345

(57) ABSTRACT

The present invention is directed, in part, to electrical connectors for engaging a mating electrical component, methods and systems comprising same. Specifically, in one embodiment, there is provided a system for engaging a mating electrical component that includes a first and second electrical connector adapted to engage different portions of the mating electrical component and spaced apart from each other. The first electrical connector has a guide post at a first end opposite said second electrical connector and the second electrical connector has a guide post at a first end opposite first electrical connector. The guide posts are adapted to support the mating electrical component therebetween, and the first electrical connector and the second electrical connector are mounted on the circuit substrate in a mirror image relationship.

### CROSS-REFERENCE TO RELATED APPLICATIONS

This application claims priority under 35 U.S.C. §119(e) to U.S. Provisional Patent Application Ser. No. 60/218,982, which was filed on Jul. 17, 2000. In addition, the subject matter disclosed herein is related to the subject matter disclosed in copending application Ser. No. 09/200,114, filed on Nov. 25, 1998, (Attorney Docket Number C4505). Both applications are herein incorporated by reference in their entirety.

### BACKGROUND OF THE INVENTION

1. Field of the Invention

The present invention relates to electrical connectors. More specifically, the present invention relates to an electrical connector having discrete sections.

2. Brief Description of Earlier Developments

Conventional card edge electrical connectors have been used to electrically connect a daughter printed circuit board (PCB) to a mother PCB. These connectors may rely upon surface mount technology (SMT), or other means, to secure the contacts of the connector to an underlying substrate such as a mother PCB. The card edge connector receives a leading edge of the daughter PCB within a longitudinal groove in an insulative housing. The connector housing includes a plurality of contacts that extend into the groove to engage conductive pads on the daughter PCB. The connector could also include latches to retain the daughter card in the groove. Card edge connectors are commonly used to electrical connect a memory module (such as a SIMM, DIMM or SODIMM) to a motherboard.

Each new generation of computer system has demanded greater amounts of memory. One solution to the escalating requirement for memory increased the amount of memory present on a memory module (e.g. using a 16MB SIMM in place of a 4MB SIMM). Since the same physical size of memory module is used, this solution does not affect the electrical connector.

Another possible solution involves increasing the physical size of the memory module (e.g. using a DIMM rather than SIMM). This solution, however, affects the electrical connector. A larger electrical connector must be used to accommodate the larger memory module.

As the size of the memory modules continues to increase, problems may arise. First, a larger connector occupies more space on the motherboard. With space on the motherboard already at a premium, a larger connector may not be desired. Thus, there is a need in the art to provide a connector or system comprising same that does not occupy unnecessary motherboard space.

Longer length connectors have a tendency to bow or warp due to the manufacturing process. Typically, the housing for the connectors are formed by a molding process that involves the application of heat. When the connector housings are removed from the mold and cooled, the connector housing tends to bow or warp. This adversely affects the conformance of the connector to the substrate on which it is mounted and may create alignment difficulties, particularly in surface mount connectors, with contact pads on the substrate or PCB. Further, it is difficult for longer length connectors to conform to the industry standards of 10,000^{th} in per in bow that is allowed on the printed circuit board. Excessive connector bow or warp could create a misalignment between the connector and the daughter card, increasing the insertion force needed to mate the daughter card with the connector. The connector bow or warp could also affect the solder joint between the connector and the motherboard.

Accordingly, there is a need in the art to provide a connector, or system comprising same, that maximizes the alignment between the connector and the circuit substrate to which the connector mounts. Further, there is a need in the art to provide an electrical connector, or system comprising same, that avoids the problems associated with bow or warp.

### SUMMARY OF THE INVENTION

The present invention satisfies these and other needs in the art by providing an electrical connector, system, or method comprising same, for engaging a mating electrical component. Specifically, in one embodiment, the system includes a first electrical connector mountable to a circuit substrate and adapted to engage a portion of the mating electrical component; and a second electrical connector mountable to the circuit substrate and spaced apart from the first electrical connector and adapted to engage another portion of the mating electrical component wherein said first electrical connector has a guide post at a first end opposite said second electrical connector and said second electrical connector has a guide post at a first end opposite first electrical connector, said guide posts adapted to support the mating electrical component therebetween, and said first electrical connector and said second electrical connector are mounted on the circuit substrate in a mirror image relationship.

In another aspect of the present invention, there is provided an electrical connector for mating with a card having an edge with conductive elements. The connector comprises: a base; contacts; and a post. The base has a first end; an opposite second end; and a channel extending between the first and second ends for receiving the edge of the card. In certain embodiments, the post is located at only the first or second end.

In a further aspect of the present invention, there is provided an electrical connector system comprising: a first circuit substrate; a second circuit substrate; and a plurality of electrical connectors. The second circuit substrate has an edge with conductive elements thereon, the conductive elements separated into a plurality of regions separated by a first distance. The electrical connectors mount to the first circuit substrate, and include: an opening to receive a corresponding one of the regions of the conductive elements of the second circuit substrate; and a plurality of contacts extending into the opening to engage the conductive elements. The opening of one connector is separated from the opening of an adjacent connector by a second distance. The second distance is approximately equal to the first distance.

In yet another aspect of the present invention, there is provided a method of connecting an electrical component to a circuit substrate. The method includes: mounting a first electrical connector to the circuit substrate; mounting a second electrical connector to the circuit substrate spaced apart from said first electrical connector wherein said second electrical connector has a slot extending therethrough that is in communication with the slot of the first electrical connector; mating a portion of the electrical component with the first electrical connector; and mating another portion of the electrical component with the second electrical connector.

In a further aspect of the present invention, there is provided a electrical connector system for engaging a mating electrical component having conductive elements, comprising: a circuit substrate having a plurality of conductive pads and a plurality of electrical connectors that are spaced apart on the circuit substrate and mounted via ball grid array technology and aligned with a portion of the conductive pads wherein each electrical connector has a plurality of contact terminals, that engage the conductive elements of the mating electrical component, such that the conductive elements of the mating electrical component are in electrical communication with the conductive pads of the circuit substrate, whereby mounting said connector mutually apart diminishes the effects of non-conformance of at least one of the circuit substrate and the connectors.

In yet another aspect of the present invention, there is provided a method of connecting an electrical component to a circuit substrate. The method comprises the steps of: providing a first electrical connector and a second electrical connector with contacts and solder balls fused to said contacts; mounting the first electrical connector and the second electrical connector to the circuit substrate wherein the second electrical connector is placed at a distance away from the first electrical connector; aligning the first electrical connector relative to the second electrical connector; fusing the solder balls to the circuit substrate; and mating a portion of the electrical component with said first electrical connector and another portion of the electrical component with said second electrical connector. In certain preferred embodiments, the solder ball fusing step performs the aligning step.

### BRIEF DESCRIPTION OF THE DRAWINGS

The foregoing summary, as well as the following detailed description of the preferred embodiments, is better understood when read in conjunction with the appended drawings.

FIG. 1 is a schematic representation of the present invention;

FIG. 2 is a plan view of one alternative embodiment of an electrical connector system of the present invention;

FIG. 3 is an elevational view, in partial cross-section, of the electrical connector system of FIG. 2;

FIG. 4 is a plan view of one component of the electrical connector system of FIG. 2;

FIG. 5 is an elevational view, in partial cross-section, of the component shown in FIG. 4;

FIG. 6 is a side view of the component shown in FIG. 4;

FIG. 7 is a cross-sectional view of the component in FIG. 4 taken along lines VII-VII; and

FIG. 8 is an elevational view, in partial cross-section, of another alternative embodiment of the electrical connector system of the present invention.

It is to be understood that both the foregoing general description and the following detailed description are exemplary and are intended to provide further explanation of the invention as claimed. The accompanying drawings are included to provide a further understanding of the invention. In the drawings, like reference characters denote similar elements throughout several views. It is to be understood that various elements of the drawings are not intended to be drawn to scale.

A more complete understanding of the present invention, as well as further features of the invention, such as its application to other electrical or mechanical devices, will be apparent from the following Detailed Description and the accompanying drawings.

### DETAILED DESCRIPTION OF THE PREFERRED EMBODIMENTS

Each of the alternative embodiments described herein relate to electrical connectors, methods, or systems comprising same, having discrete sections that are properly aligned with respect to each other. The electrical connectors of the present invention, and the systems and methods comprising same, are spaced apart on a substrate tom diminish the effects of non-conformance of at least one of the substrate and the connectors. The term “non-conformance” as used herein generally relates to the problems associated with bowing and warping of the connectors and substrate during fabrication of the connectors and substrate and mounting of the connectors to the substrate, or any other type of deformation discussed herein. In certain preferred embodiments of the present invention, the connectors are surface mounted to a substrate having conductive pads using ball grid array (BGA) technology. Preferably, fusible elements, such as solder balls, secure the contacts to conductive elements on the substrate using ball grid array (BGA) technology. Each alternative embodiment will now be described in more detail below.

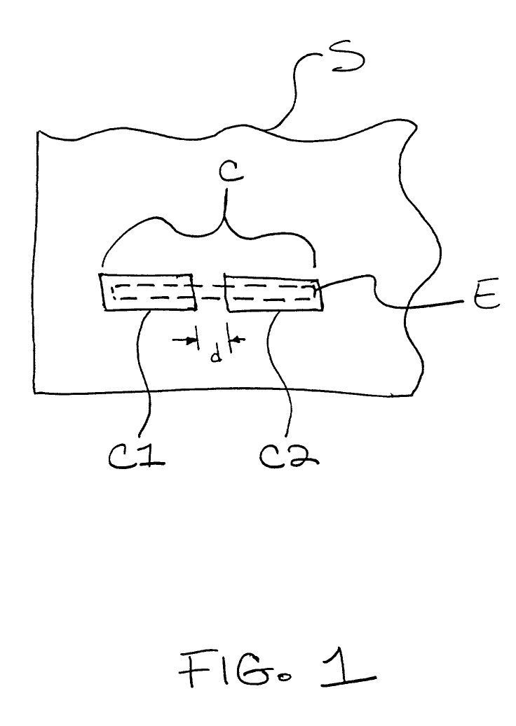

FIG. 1 provides a schematic representation of one embodiment of the present invention. Generally speaking, the present invention may comprise an electrical connector system C that connects an electrical component E to a substrate S. As FIG. 1 illustrates, connector system C has a plurality of discrete sections C1 and C2 which are mounted to substrate S and separated by a distance d. Although separated, discrete sections C1 and C2 are sufficiently aligned on substrate S to receive a common electrical component referred to in FIG. 1 as E. In certain embodiments of the present invention, sections C1 and C2 both have a channel extending therethrough that is aligned with respect to each other to receive component E. In certain preferred embodiments of the present invention, sections C1 and C2 are mounted onto substrate S in a mirror image relationship. Thus, sections C1 and C2 can receive a common electrical component E as if sections C1 and C2 were a unitary connector.

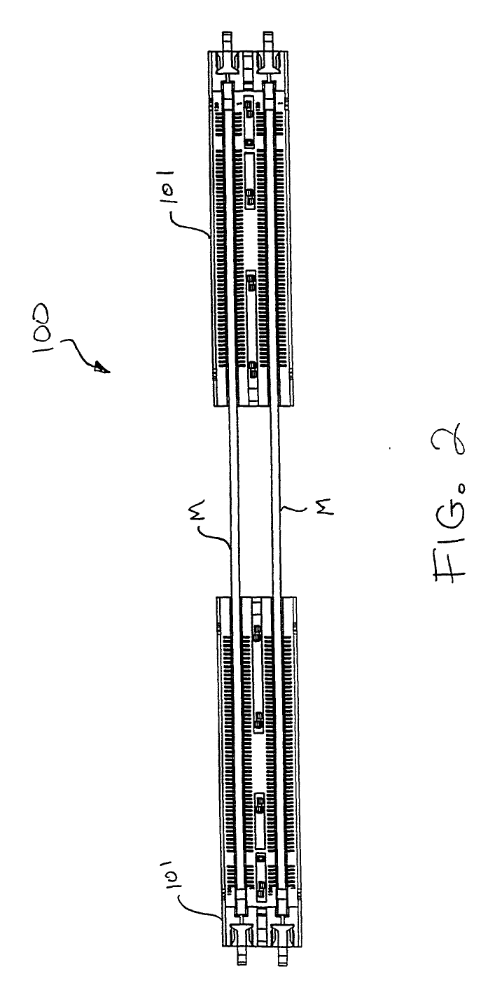

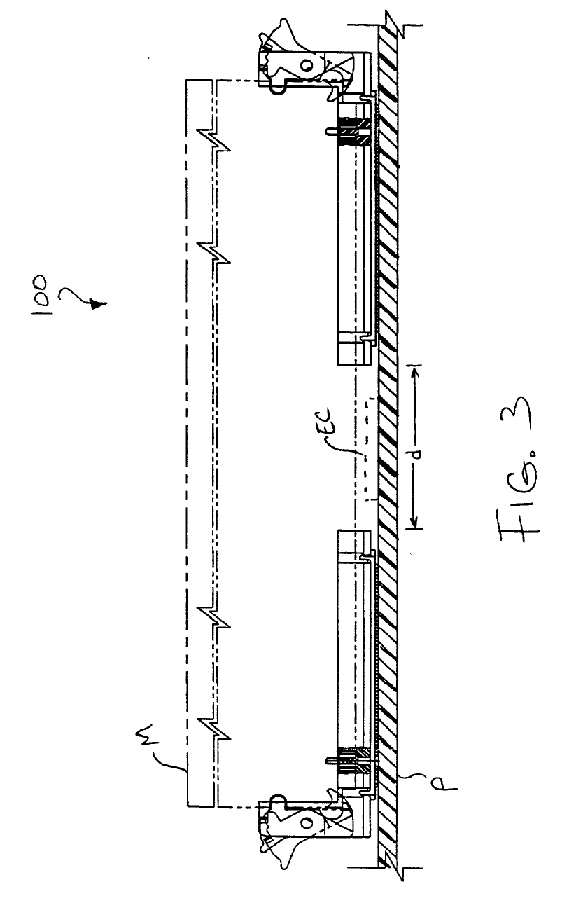

FIGS. 2 and 3 provide an illustration of an alternative embodiment of the electrical connector system of the present invention. FIG. 2 provides a plan view of the electrical connector system. FIG. 3 provides an elevational view, in partial cross-section, of the electrical connector system of FIG. 2. Electrical connector system 100 connects daughter cards, such as memory modules M, to a mother circuit substrate, such as printed circuit board P (P not shown in FIG. 2). Although FIGS. 2 and 3 display two memory modules M within system 100, connector system 100 could connect only one module M, or more than two modules M as necessary.

As seen in FIGS. 2 and 3, connector system 100 comprises a plurality of discrete connector sections 101. Each connector section 101 mounts to motherboard P, separated from the other section 101 by a distance d. Although discrete, connector sections 101 may be sufficiently aligned on motherboard P to receive memory modules M as if connector system 100 was unitary. Proper alignment occurs by mounting sections 101 to motherboard P with a variety of techniques, including, for example, surface mount technologies such as ball grid array (BGA) technology. Preferably, sections 101 are mounted onto motherboard P via BGA technology. This aspect of the present invention will be discussed in more detail below.

In embodiments where space on the motherboard P is at a premium, the board designer could place an electronic component EC in the space between connector sections 101 if needed (see, for example, the dashed area denoting electrical component EC on FIG. 3).

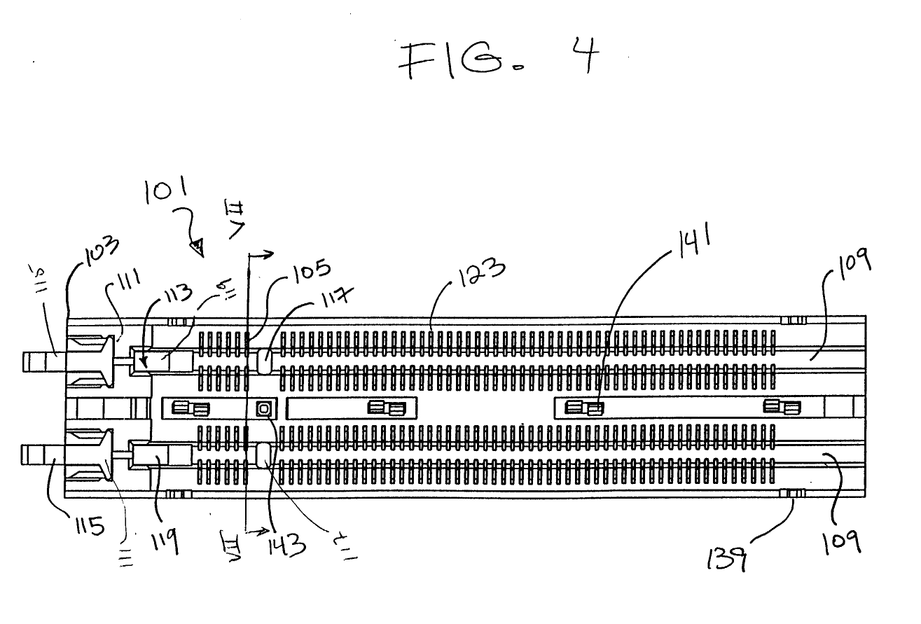

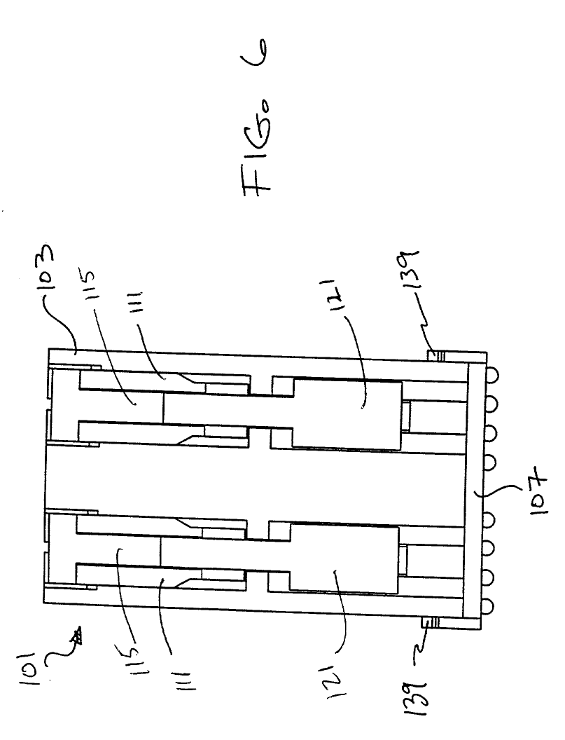

FIGS. 4-7 provide further, more detailed views of connector section 101 of FIGS. 2 and 3. Connector section 101 includes a housing 103, contact terminals 105 and retention member 107. Connector section 101 preferably has a pitch between terminals of about 1.5 mm or below, preferably about 1.25 mm or below, and more preferably about 1.0 mm or below. Preferably contact terminals 105 are mounted onto a first substrate, such as a motherboard P, and engage one or more contacts of an electrical component of a second substrate, such as a memory card M, to electrically connect the first substrate to the second substrate. This may allow electrical communication to be selectively established between memory card M and motherboard P. Each component will now be discussed in detail.

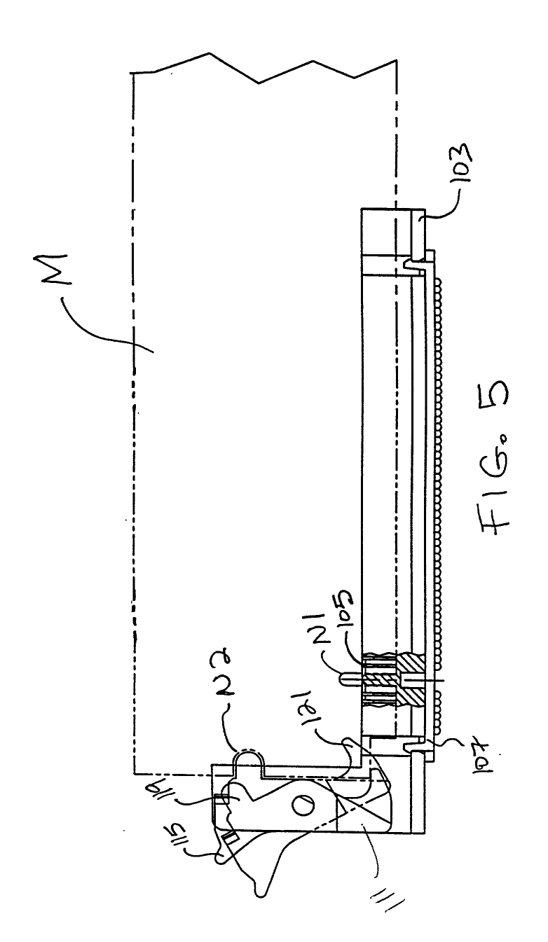

Referring to FIG. 4, housing 103 is preferably made from a suitable insulative material such as, for example, a glass-filled liquid crystal polymer (LCP). For each memory module M, slot 109 extends between opposing sides of housing 103. Slot 109 receives the edge of memory module M. While FIG. 4 is shown with two slots 109 to accommodate two electronic components, such as a memory module M, the concepts discussed herein are equally applicable to connector section 101 with one slot 109 or multiple slots 109. A polarizing feature, such as block 117 resides in slot 109 to ensure proper orientation of memory module M in connector 101. Referring to FIG. 5, memory module M has a corresponding notch N1 along its edge to receive block 117. It is understood that other configurations that allow for memory module M to align itself within slot 109 may also be contemplated.

Referring again to FIG. 4, housing 103 may include a guide post 111 for each memory module M. As seen previously in FIG. 3, in certain preferred embodiments only one end of housing 103 has guide post 111. Accordingly, the opposite end of housing 103 would not have a guide post. In such embodiments, slot 109 would extend completely to the end of housing 103 lacking the guide post. In alternative embodiments, housing 103 may have guide posts 111 at both ends, or at a location other than the ends.

Guide post 111 has a groove 113 in communication with slot 109. Groove 113 also receives the edge of memory module M. As shown in FIG. 5, post 111 has a pivotally attached latch 115 to retain memory module M in connector section 101. Latch 115 has a projection 119 that resides in a notch N2 in memory module M when latch 115 is closed (e.g. the vertically oriented latch in FIG. 5). Projection 119 helps prevent accidental removal of memory module M from connector system 100.

Referring again to FIG. 5, latch 115 also has a foot 121 that helps eject memory module M from connector system 100. Foot 121 abuts the edge of memory module M as latch 119 rotates counterclockwise from its vertical orientation to the ejecting position (shown in phantom lines in FIGS. 3 and 5). Other configurations that allow for the connector system 100 to secure and eject memory module M from connector sections 101 may also be used. In certain embodiments comprising a plurality of connector sections 101 which allow for the insertion of one memory module M within a system, only one connector section 101 within the system may comprise latch 115 and foot 121 for inserting and ejecting memory module M.

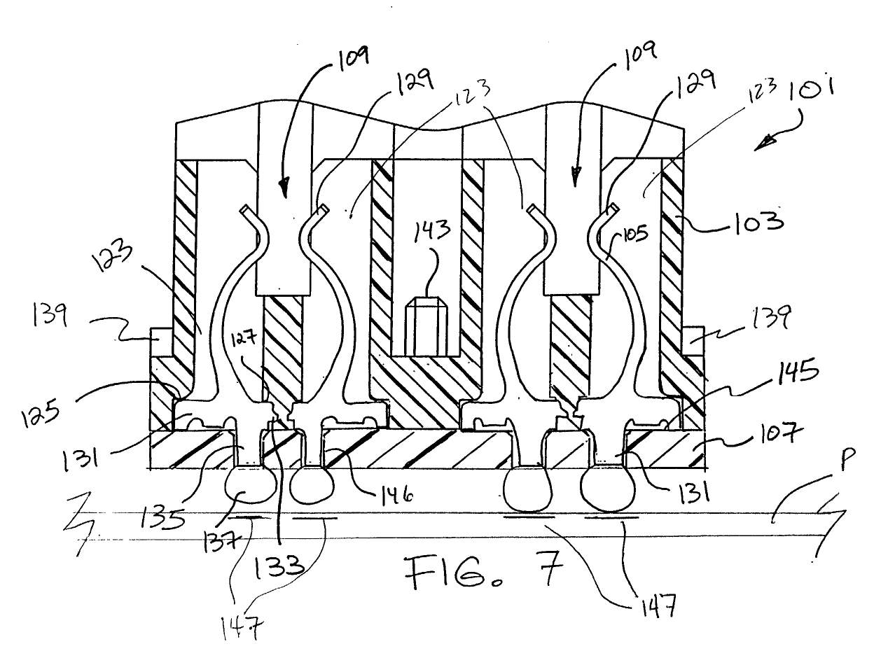

Referring back to FIG. 4, housing 103 includes openings 123 within housing 103 through which contacts 105 extend. Openings 123 are preferably of dimensions to be sufficiently narrow to limit the lateral movement of contacts 105, but allow deflection of contacts 105 about the longitudinal axis when mating with memory module M. Referring to FIG. 7, opening 123 may have shoulders 125 and 127 that are adjacent to the open bottom of housing 103. Shoulders 125 and 127 help position contacts 105 in housing 103.

FIG. 7 provides one illustration of how contacts 105 may be positioned within housing 103. Contacts 105 may be comprised of any suitable conductive material. A mating section 129, which is preferably the distal end of contact 105, extends from opening 123 and into slot 109 to engage the edge of memory module M.

An intermediate section 131 retains contact 105 in housing 103. Intermediate section 131 abuts shoulders 125 and 127 of housing. Further, intermediate section 131 may include a barb 133 that pierces a side wall of opening 123. As will be further discussed below, barb 133 temporarily retains contact 105 in housing 103 prior to securing retention member 107 to housing 103.

A mounting section 135 extends from intermediate section 131 opposite to mating section 129. Mounting section 135 may use any type of contact termination, such as, but not limited to, press-fit, pin-in-paste, or surface mount technology techniques (SMT) to secure connector section 101 to motherboard P (not shown in FIG. 7). In preferred embodiments, mounting section 135 within connector section 101 is secured to motherboard P via surface mount technology such as BGA.

Retention member 107 prevents contacts 105 from dislodging from opening 123. As discussed above, the inserted contacts 105 are temporarily retained in opening 123 by barbs 133. Thereafter, retention member 107 secures to housing 103 using laterally located latches 139, medially located latches 141 and alignment post 143. Once secured to housing 103, an upper surface 145 of retention member 107 abuts portions of intermediate section 131 of contact 105, and mounting sections 135 of contacts 105 extend through apertures 146 in retention member 107. While mounting sections 135 are shown contained within apertures 146 within retention member 107, it is understood that mounting sections may also abut retention member 107. Further, retention member 107, which is depicted in FIG. 7 as having a planar surface, may comprise wells or recessed areas (not shown) wherein mounting sections 135 reside to influence the coplanarity at the connector section 101 and substrate P interface.

FIG. 7 displays the use of a preferred surface mount technology, a SMT technique referred to as ball grid array (BGA) attachment. U.S. Pat. Nos. 6,139,336 and 6,024,584, and U.S. patent application Ser. No. 09/845,631 filed Apr. 30, 2001, herein incorporated by reference in their entireties, describe in detail exemplary methods of securing a fusible element to a contact and to a PCB. A brief summary of such a BGA process, as it applies to the connectors, systems, and methods comprising same of the present invention, follows.

Using BGA attachment, mounting section 135 can be a tab to which a fusible element, such as a solder ball 137, fuses. In preferred embodiments, mounting section 135 may be plated with a solderable metal such as gold, or other precious metal, or tin. Above this, contact 105 may be preferably plated with a non-solderable metal such as nickel. Further above in the contact area, there may be preferably gold, or other precious metal, plating. With this plating system, undue wicking of solder from the recess area up the contact will be avoided. In other alternative embodiments, the entire contact may be plated with gold, or other precious metal, if a suitable fluorine based anti-wicking coating is used.

After retention member 107 secures to housing 103, at least a portion of mounting section 135 resides within aperture 146. With mounting section 135 in aperture 146, solder paste (not shown) is placed in aperture 146 using, for example, a squeegee (not shown). A fusible element, solder balls 137, are then placed on the deposits of solder paste. The connector section 101, with solder balls 137, are placed in an oven for a time and at a temperature sufficient to reflow the solder paste/solder balls to contacts 105.

A second reflow step is preferably used to mount connector sections 101, with fused solder balls 137, to conductive pads 147 on a substrate, such as motherboard P. The substrate may have a plurality of conductive pads that are connected to suitable traces (not shown in FIG. 7) to transmit signals or for grounding purposes, for example. Alternatively, the conductive pads on the substrate may also be vias. The pads on the substrate correspond to the plurality of fusible elements, such as solder balls 137 that are secured to contacts 105 in connector section 101. Before the second reflow step, solder paste (not shown) is preferably introduced onto the conductive pads 147 of motherboard P using, for example, the aforementioned squeegee. The second reflow process then fuses 137 to conductive pads 147 on motherboard P. Although described as two reflow steps, the steps could be combined into a single step if desired. It is understood, however, any number of steps may be used to mount connector sections 101 to the conductive pads on motherboard P.

When using BGA attachment, suitable alignment between discrete connector sections 101 occurs as a result of the “self-centering” characteristic of solder ball 137. Self-centering occurs when a connector is misregistered on a PCB such as motherboard P. In other words, the solder balls are not precisely aligned with the pads on the PCB. Despite the misalignment, the reflowed solder balls tend to revert to a proper position, i.e., substantially aligned with the pads on the PCB.

Since each connector section 101 is substantially aligned with respective pads 147 on motherboard P, connector sections 101 are necessarily aligned with each other. Therefore, despite distance d, connector sections 101 receive memory module M as if connector system 100 was a unitary piece. Once inserted therein, one or more latches 115 are actuated to secure memory modules M to connector system 100. The tasks are reversed to remove memory modules M from connector system 100.

As seen in FIG. 3, the self-centering characteristic of solder balls 137 obviates the need for an alignment post on connector section 101 to extend into a corresponding guidance hole in motherboard P. Connector system 100 could, however, include alignment posts (not shown), particularly if an attachment method other than BGA is used.

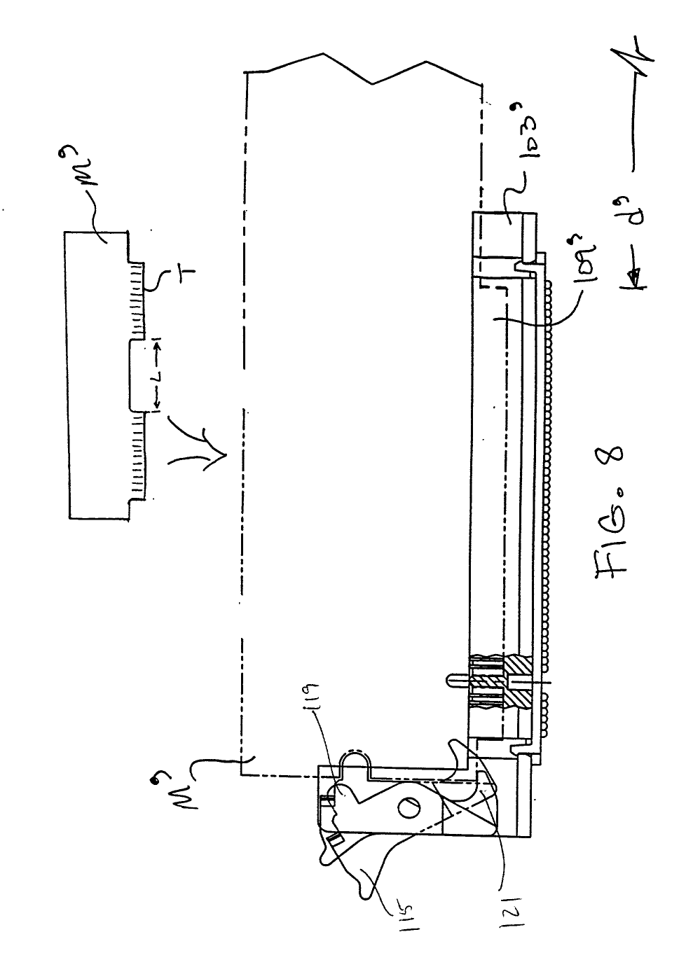

FIG. 8 provides an elevational view, in partial cross-section, of a further alternative embodiment of the present invention. Features different than the aforementioned embodiment will use the same reference character, except for the addition of a prime (i.e.′).

In situations where memory module M′ places the conductive pads on tabs T extending from the card edge, slot 109′ of housing 103′ need not extend completely to the side of housing 103′. Instead, housing 103′ could have a wall (not shown) at the side of housing 103′ to abut the side edge of tab T. With this arrangement, a distance L, that extends between tabs T, would be equal to a distance d′ between the slots 109′ in adjacent connectors 101′.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. An electrical connector system for engaging a mating electrical component, comprising:
a first electrical connector mountable to a circuit substrate and adapted to engage a portion of the mating electrical component; and
a second electrical connector mountable to the circuit substrate and spaced apart from said first electrical connector and adapted to engage another portion of the mating electrical component;
wherein said first electrical connector has a guide post at a first end opposite said second electrical connector and said second electrical connector has a guide post at a first end opposite first electrical connector, said guide posts adapted to support the mating electrical component therebetween, and said first electrical connector and said second electrical connector are mounted on the circuit substrate in a mirror image relationship.

2. The electrical connector system as recited in claim 1, wherein said first and second electrical connectors are identical.

3. The electrical connector as recited in claim 1, wherein said first electrical connector has a second end facing said second electrical connector, said second electrical connector has a second end facing said first electrical connector, said second ends lacking guide posts.

4. The electrical connector system as recited in claim 1, wherein said first and second electrical connectors are card edge connectors.

5. The electrical connector system as recited in claim 1, wherein said first and second electrical connectors each have contacts with surface mount features.

6. The electrical connector system as recited in claim 5, wherein said surface mount features are fusible elements.

7. The electrical connector system as recited in claim 6, wherein said fusible elements are solder balls.

8. The electrical connector system as recited in claim 1, wherein said first and second electrical connectors are each adapted to engage two mating electrical components.

9. The electrical connector system as recited in claim 1, further comprising a circuit substrate to which said first electrical connector and said second electrical connector are adapted to mount.

10. An electrical connector for mating with a card having an edge with conductive elements, the electrical connector comprising:
a base, including:
a first end;
an opposite second end; and
a channel extending between said first end and said second end, said channel adapted to receive the edge of the card;
a plurality of contacts in said channel to engage the conductive elements of the card; and
a post extending from said base for supporting a portion of the card extending from the channel;
wherein said post is located at only one of said first end and said second end.

11. The electrical connector as recited in claim 10, wherein said post includes a latch for retaining the card in the channel.

12. The electrical connector as recited in claim 11, wherein said latch is pivotally mounted to said post for ejecting the card from the channel.

13. The electrical connector as recited in claim 10, further comprising a second channel extending between said first end and said second end, said channel adapted to receive an edge of a second card.

14. The electrical connector as recited in claim 10, in combination with a generally identical second electrical connector and a circuit substrate, wherein said electrical connector and said second electrical connector are mounted to said circuit substrate.

15. The electrical connector as recited in claim 10, wherein said contacts have surface mount features.

16. The electrical connector as recited in claim 15, wherein said surface mount features are fusible elements.

17. The electrical connector as recited in claim 16, wherein said fusible elements are solder balls.

18. An electrical connector system, comprising:
a first circuit substrate;
a second circuit substrate having an edge with conductive elements thereon, said conductive elements separated into a plurality of regions separated by a first distance; and
a plurality of electrical connectors mounted to said first circuit substrate, each connector including:
an opening to receive a corresponding one of said plurality of regions of said conductive elements of said second circuit substrate; and
a plurality of contacts extending into said opening to engage said conductive elements;
wherein said opening of one of said plurality of connectors is separated from said opening of an adjacent one of said plurality of connectors by a second distance, said second distance approximately equal to said first distance.

19. The electrical connector system as recited in claim 18, wherein said edge of said second circuit substrate includes a plurality of tabs extending therefrom, each of said plurality of regions corresponding to a respective one of said plurality of tabs.

20. The electrical connector system as recited in claim 18, wherein said second circuit substrate is a memory module.

21. The electrical connector system as recited in claim 18, wherein said second circuit substrate has a first side and an opposed second side, said edge extending between said first and second sides, and said connectors associated with said first and second sides of said second circuit substrate each include a guide post.

22. A method of connecting an electrical component to a circuit substrate, comprising the steps of:
mounting a first electrical connector to the circuit substrate wherein said first electrical connector has a guide post and a slot extending therethrough;
mounting a second electrical connector to the circuit substrate spaced apart from said first electrical connector wherein said second electrical connector has a slot extending therethrough that is in communication with the slot of the first electrical connector;
mating a portion of the electrical component with said first electrical connector; and
mating another portion of the electrical component with said second electrical connector.

23. The method as recited in claim 22, wherein the first electrical connector mounting step and the second electrical connector mounting step comprise surface mounting said first electrical connector and said second electrical connector to the circuit substrate.

24. The method as recited in claim 22, wherein the first electrical connector surface mounting step and the second electrical connector surface mounting step include the steps of:
providing said first electrical connector and said second electrical connector with contacts and solder balls fused to said contacts; and
fusing said solder balls to the circuit substrate.

25. The method as recited in claim 24, further comprising the step of aligning said first electrical connector relative to said second electrical connector.

26. The method as recited in claim 25, wherein the solder ball fusing step performs the aligning step.

27. The method as recited in claim 26, wherein the aligning step is performed without using an aperture in the circuit substrate.

28. An electrical connector system for engaging a mating electrical component having conductive elements, comprising:
a circuit substrate having a plurality of conductive pads; and
a plurality of electrical connectors that are spaced apart on the circuit substrate and mounted via ball grid array technology and aligned with a portion of the conductive pads wherein each electrical connector has a plurality of contact terminals, that engage the conductive elements of the mating electrical component, such that the conductive elements of the mating electrical component are in electrical communication with the conductive pads of the circuit substrate;
whereby mounting said connectors mutually apart diminishes effects of non-conformance of at least one of the circuit substrate and the connectors.

29. A method of connecting an electrical component to a circuit substrate, comprising the steps of:
providing a first electrical connector and a second electrical connector with contacts and solder balls fused to said contacts;
mounting the first electrical connector and the second electrical connector to the circuit substrate wherein the second electrical connector is spaced apart from the first electrical connector;
aligning the first electrical connector relative to the second electrical connector;
fusing the solder balls to the circuit substrate; and
mating a portion of the electrical component with said first electrical connector and another portion of the electrical component with said second electrical connector.

30. The method as recited in claim 29, wherein the solder ball fusing step performs the aligning step.

31. The method as recited in claim 29, wherein the aligning step is performed without using an aperture in the circuit substrate.
